(19) United States
(12) Patent Application Publication
(10) Pub. No.: US 2012/0171632 A1
(43) Pub. Date: Jul. 5, 2012

(54) DEVICE AND TREATMENT CHAMBER FOR THERMALLY TREATING SUBSTRATES

(75) Inventors: Emmerich Manfred Novak, Kloster Lehnin (DE); Jutta Trube, Mombris (DE)

(73) Assignee: LEYBOLD OPTICS GMBH, Alzenau (DE)

(21) Appl. No.: 13/386,715

(22) PCT Filed: Aug. 12, 2010
(86) PCT No.: PCT/EP2010/004947

§ 371 Date: Mar. 8, 2012

(30) Foreign Application Priority Data
Aug. 14, 2009 (DE) 10 2009 037 299.7

(51) Int. Cl. F27D 15/02

(52) U.S. Cl. 432/14; 432/77

(57) ABSTRACT

A treatment chamber for thermal processing of an areal substrate including a transport arrangement for conveying and supporting the substrate during the thermal processing and a gas-guiding arrangement for convective heating or cooling of the substrate, where the gas-guiding arrangement has outlet openings, by means of which the temperature-controlled gas is guided onto the substrate, and where a removal arrangement is provided, by means of which the gases introduced into the treatment chamber via the gas-guiding arrangement can be removed in a targeted fashion, such that the treatment chamber can be embodied as a heat-treatment chamber or as a cooling chamber.

### TECHNICAL FIELD

The invention relates to a treatment chamber for thermal processing of a substrate. The treatment chamber can be embodied as a heat-treatment chamber (heating chamber) or as a cooling chamber. The invention furthermore relates to a device with a heat-treatment and a cooling chamber for thermal processing of a substrate and also to a method for thermal processing of a substrate.

### BRIEF DISCUSSION OF RELATED ART

Process steps are often required during the surface treatment of substrates, for example when applying transparent conducting oxide (TCO) layers during the production of flat-panel displays and solar cells or when coating substrates using CIGS thin-layer technology, during which steps the substrate (together with the coatings possibly applied to the substrate) is subjected to a thermal pre- and/or post-treatment. For this purpose, the substrate is typically heated to the desired temperature with the aid of a heat source, kept at this temperature for a prescribed time, and is subsequently cooled. In the process, it is generally advantageous to obtain the fastest possible heating and/or cooling of the substrate for process-economical and/or technical reasons. However, at the same time, it must be ensured that the temperature gradients in the interior of the substrate are as low as possible during the heating and cooling, because otherwise transient or permanent deformations of the substrate occur and these can lead to damage to the coating (tears, inner stresses, etc.) and/or the substrate (deformations, formation of bubbles, bi-stable states of the substrate material etc.). This problem is aggravated in the case of substrates made of materials with a low thermal conductivity, e.g. glass materials, because temperature differences within the substrate can only equilibrate slowly in these materials.

In order to confront this problem, DE 698 12 251 T2 proposes the use of a semi-convective forced air system for heating the substrate. In the process, the substrate is heated firstly by radiation with the aid of electrical resistance heating elements and secondly by air distributors that guide the heated air in the direction of the substrate. The convection heat supplied by the air distributors thus supports the radiant heat supplied by the electrical resistance elements. Furthermore, targeted (local) convection heating can counteract a temperature gradient generated by the radiant heating. This is intended to achieve heating with a more even temperature profile over the substrate. In the process, the air distributors are fed by a circulation pump (ventilator) arranged within or outside of the heat-treatment chamber.

### BRIEF SUMMARY

The invention provides a heat-treatment chamber and/or a cooling chamber and also a method for thermal processing of substrates that allow the local heating or cooling of the substrate to be controlled particularly well and achieve fast heating and/or cooling of a substrate in a particularly efficient and cost-effective fashion, without this resulting in damage to the substrate or the coatings as a result of thermal gradients. Furthermore, provision should be made for a device with a heat-treatment chamber and a cooling chamber for thermal processing of substrates.

Accordingly, the substrate is heated or cooled by convection of a temperature-controlled gas, which is guided onto the substrate by a gas-guiding arrangement.

The treatment chamber, in which the substrate is held during the thermal treatment, comprises a removal arrangement for the targeted removal of the gas by means of which the substrate is heated or cooled by convection. This removal arrangement affords the possibility of a defined return feed, more particularly a reuse of the gas used for heating or cooling.

The treatment chamber is an enclosed space in an advantageous refinement of the invention. The substrate is introduced into the treatment chamber through a lock and conveyed and supported there with the aid of a transport arrangement. In such a thermal treatment chamber that can be sealed in a gas-tight fashion, the gas used for heating or cooling is advantageously supplied and removed in a closed gas circuit, which comprises the gas-guiding arrangement, the interior of the treatment chamber and the removal arrangement. This is particularly advantageous when the thermal treatment is carried out with the aid of gases that are reactive or toxic and therefore should not emerge into the surroundings. Furthermore, the proportion of heating or cooling power that could not be transferred from the gas to the substrate is not lost, but again flows to the gas-guiding arrangement via the removal arrangement and through the closed circuit. This affords the possibility of saving heating and cooling energy.

The removal arrangement is advantageously designed such that it allows a locally defined removal of the gas guided onto the substrate such that the gas emerging from an outlet opening of the gas-guiding arrangement is suctioned off in the direct vicinity of these outlet openings. Individual outlet openings (or groups of outlet openings) can be associated with removal domes that are shaped such that they remove the temperature-controlled gas emerging from these outlet openings in a targeted fashion. The heating or cooling gas thus only meets the substrate in a locally delimited region and is suctioned off locally before it can spread. This allows a very differentiated and controlled local heating or cooling of the substrate, and thermal gradients in the substrate can be avoided (or created in a targeted fashion). Suctioning off the gas directly in the vicinity of the outlet openings can furthermore prevent the gas from contacting the walls of the treatment chamber. This is particularly of great advantage if an industrial gas (e.g. a corrosive or toxic gas) is used for the convective heating or cooling, which gas can cause contamination or damage to the chamber walls. The removal arrangements thus act as shielding devices that protect the chamber walls from the influence of the gas.

The outlet openings of the gas-guiding arrangement are advantageously embodied as nozzles, with the aid of which the gas flow can be guided to a region of the substrate surface lying opposite the nozzle in a targeted fashion (for example in a defined focussed or unfocussed fashion). The nozzles and/or the tube sections of the gas-guiding arrangement associated with the nozzles can be provided with controllable valves. Then a control arrangement can actuate the valves in the nozzles individually or in groups in order to control the amount and/or the speed of the gas emerging through the nozzle.

In order to control the temperature of the gas that is used for convection heating or cooling of the substrate, the gas-guiding arrangement expediently contains a heat exchanger, with the aid of which the gas is brought to the desired temperature. If the gas is intended to be heated, the gas-guiding arrangement can contain an electrically operable heating device as an alternative to, or in addition to, the heat exchanger. Furthermore, the gas-guiding arrangement contains a pump, with the aid of which the gas is conveyed onto the substrate. If the gas-guiding arrangement is part of a closed gas circuit, the pump simultaneously serves to suction off via the removal arrangement the gas that emerged from the outlet openings. The pump can be operated with open-loop or closed-loop control. Furthermore, the gas-guiding arrangement can contain a drying device and/or a filter device for cleaning the gas supplied to the substrate surface; this is particularly expedient when the convection heating or cooling is brought about in a closed gas circuit because this allows the circulating gas to be dried and/or cleaned regularly.

If the treatment chamber is used for heating substrates, provision can additionally be made in the treatment chamber for heating means, more particularly electrical resistance heating elements, that supply radiant heat to the substrate—in addition to the gas—guiding arrangement for convective heating of the substrate. The walls of the treatment chamber can comprise a heat-reflecting material in order to guide the power radiated by the heating means in the direction of the substrate.

The treatment chamber can be provided with a thermoinsulation shield for thermal shielding of the treatment chamber, the interior of which is intended to be heated or cooled during operation, against the surroundings. This can achieve faster heating or cooling of the chamber interior, more particularly of the substrate, and the heating or cooling power required to maintain a desired temperature can be reduced. By way of example, the thermoinsulation shield can be embodied as an outer chamber that can be sealed in a gas-tight fashion, more particularly as a vacuum chamber, and surrounds the inner chamber, in which the thermal processing of the substrate takes place, on all sides. The cavity situated between the inner and outer chamber insulates the (heated or cooled) inner chamber from the surroundings.

Alternatively, the thermoinsulation shield can be formed by a temperature-control arrangement—preferably arranged in the wall of the treatment chamber—that actively cools or heats the chamber wall. More particularly, the treatment chamber can be provided with a channel system that is integrated into the chamber wall and in which a liquid heating or cooling medium, for example an oil, circulates. If the treatment chamber is a heating chamber operated at high temperatures, the chamber walls can be cooled in a targeted fashion in order to minimize the thermal load on the surroundings, more particularly a vacuum chamber surrounding the heating chamber.

### BRIEF DESCRIPTION OF THE DRAWINGS

Hereinbelow, the invention will be explained in more detail with the aid of an exemplary embodiment illustrated in the figures, in which:

FIG. 1 shows a schematic sectional view of a device for thermal processing of substrates, with a heat-treatment chamber and a cooling chamber;

FIG. 2a shows a schematic sectional view of the heat-treatment chamber from FIG. 1 with a closed gas-guiding circuit; and

FIG. 2b shows a sectional view of the heat-treatment chamber from FIG. 2a as per the cut-line IIb-IIb in FIG. 2a.

### DETAILED DESCRIPTION

In the drawings, mutually corresponding elements are denoted by the same reference sign. The drawings illustrate a schematic exemplary embodiment and do not reproduce any specific parameters of the invention. Furthermore, the drawings only serve to explain an advantageous embodiment of the invention and should not be interpreted as restricting the scope of protection for the invention.

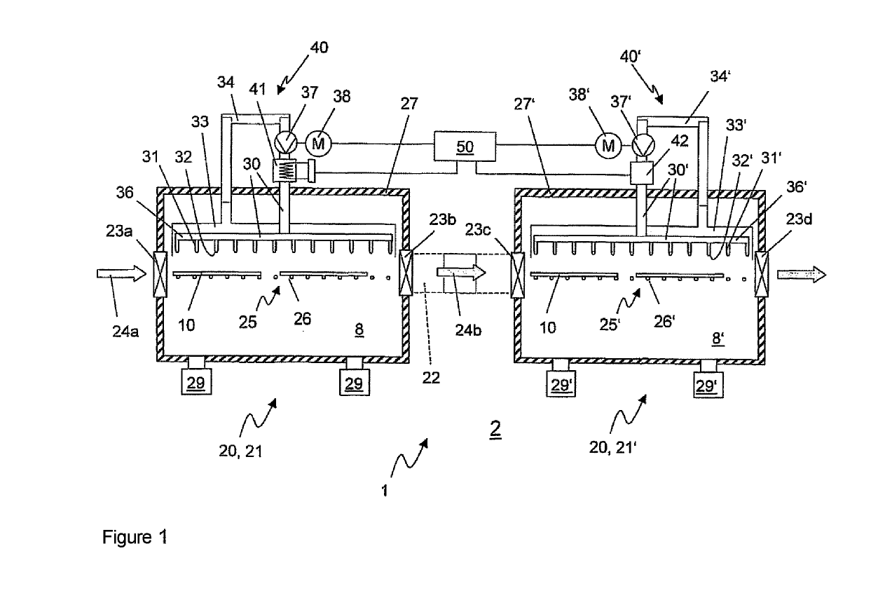

FIG. 1 shows a schematic sectional view of a device 1 for thermal processing of substrates 10. Here, the term “substrate” should be understood to be any object that needs to be processed or coated and/or already has been coated, that is to say both a (possibly pre-treated) substrate material as such and a substrate material with single or multiple coats. In the exemplary embodiment shown in the figures, the substrate is an areal workpiece made of glass, the surface area of which can range between a few square centimetres and a few square metres. “Thermal processing” should be understood to mean any process or process step that is performed in conjunction with heating and/or cooling of the substrate.

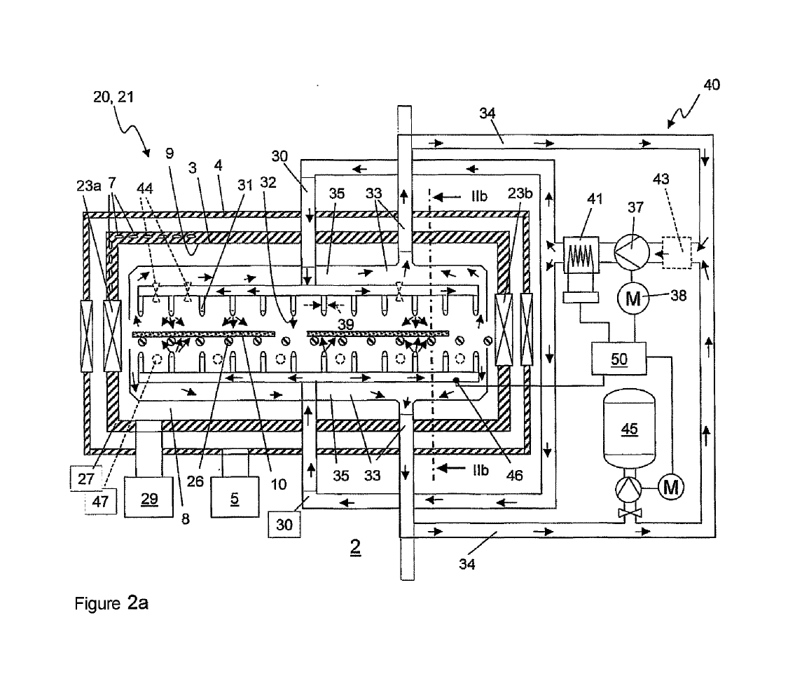

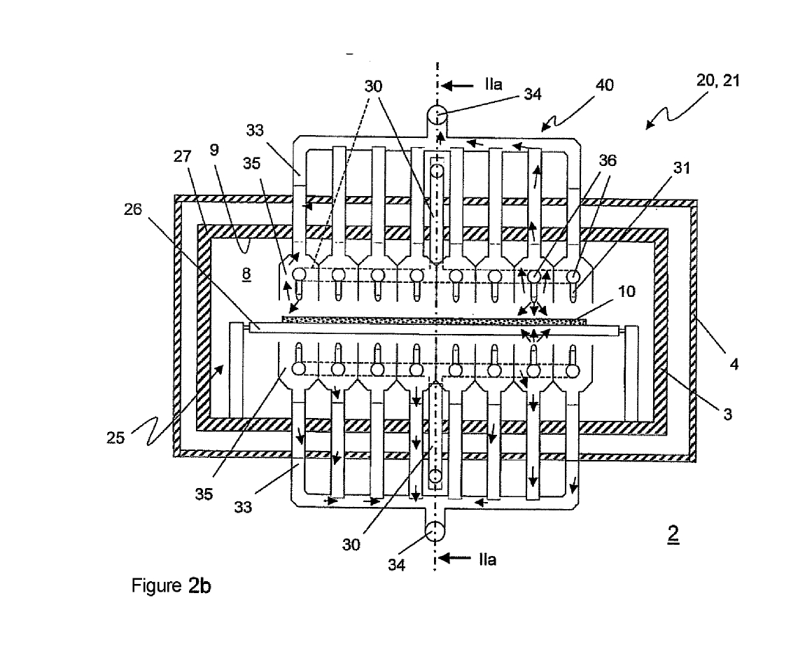

The device 1 comprises two thermal treatment chambers 20, namely a heat-treatment chamber 21 and a cooling chamber 21′. Sectional views of the heat-treatment chamber 21 are shown in detail in FIGS. 2a and 2b. The substrate 10 to be treated is inserted via a lock 23a into the heat-treatment chamber 21 (arrow 24a), where the substrate 10 is heated by convection with the aid of a heated gas that is introduced into the heat-treatment chamber 21 via a gas-guiding arrangement 30. The substrate 10 is subsequently transported through the locks 23b and 23c into the cooling chamber 21′ (arrow 24b) and there it is cooled by convection with the aid of a temperature-controlled (generally cooled) gas that is introduced into the cooling chamber 21′ via a gas-guiding arrangement 30′. Further process stages 22 can be provided between the heat-treatment chamber 21 and the cooling chamber 21′, and this is indicated in FIG. 1 by dashed connecting lines.

A transport arrangement 25, indicated in FIG. 1 as a collection of horizontally aligned, rotatably mounted transport rollers 26 on which the areal substrate 10 lies, is used for transporting and supporting the substrate 10 in the heat-treatment chamber 21 and in the cooling chamber 21′. Alternatively, the substrate can be arranged and transported in the treatment chambers 20 at any angular position, more particularly also vertically or angled by a small angle with respect to the vertical direction.

Thus a gas atmosphere, preferably approximately at normal pressure, prevails in the thermal treatment chambers 20 during the thermal processing of the substrate 10. The gas can be air, but also an inert gas or a reactive gas. The gas is guided onto the substrate 10 with the aid of the gas-guiding arrangement 30, 30′ via nozzle sections 31, 31′, removed from the thermal treatment chamber 20 via a removal arrangement 33, 33′, and resupplied to the gas-guiding arrangement 30, 30′ via a return feed 34, 34′. The detailed views of FIGS. 2a and 2b show that the removal direction 33 of the heat-treatment chamber 21 comprises removal domes 35, which are arranged directly above the nozzle sections 31 of the gas-guiding arrangement 30, and so the gas emerging from the nozzles 31 impinges on the substrate surface 10, brings about a heating of the substrate 10 there and is subsequently suctioned off immediately via the removal domes 35 (small arrows in FIGS. 2a and 2b). This achieves local heating of the substrate 10 and prevents the gas from reaching the walls 27 of the treatment chamber 20. The nozzle sections 31 are arranged on tubular gas distributors 36, 36′, from which they protrude in the direction of the substrate 10. There are outlet openings 32 on the ends of the nozzle sections 31 facing the substrate 10, which outlet openings are designed such that they permit a targeted (focussed or unfocussed) gas actuation of the substrate surface 10. In the exemplary embodiment shown in FIGS. 2a and 2b, the cross sections 39 of the nozzle sections 31 taper towards the outlet openings 32, and so a directed gas flow is generated. The nozzle sections 31 are designed such that the gas emerging from the outlet openings 32 for heating or cooling the substrate 10 does not cause any pressure load worth mentioning on the substrate 10.

The gas distributors 36 and/or the nozzle sections 31 can be provided with controllable valves 44, which permit a targeted increased or reduced gas flow in selected gas distributors or nozzle sections and thereby allow the heating power emitted onto the substrate 10 to be varied locally. This affords the possibility of generating a very precisely dosed, locally variable gas profile—and thus a targeted influence on the local heating or cooling generated by means of the gas in the substrate 10 can be achieved. This affords the possibility of avoiding temperature-dependent inhomogeneities in the substrate 10, which leads to good temperature evenness.

The treatment chamber 20 can be sealed in a gas-tight fashion with respect to the surroundings 2, and so the interior 8 thereof forms an enclosed space during the processing of the substrate 10. Vacuum pumps 29, 29′ are provided for evacuating the treatment chamber 20. The respective temperature-controlled gas circulates in a closed gas circuit 40, 40′ in each treatment chamber 21, 21′, which gas circuit is formed by the gas-guiding arrangement 30, 30′, the interior 8, 8′ of the respective treatment chamber 21, 21′, the removal device 33, 33′ and the return feed 34, 34′. Arranged in the gas-guiding arrangement 30, 30′ there is a pump 37, 37′ with a drive 38, 38′, which is connected to a control arrangement 50 and with the aid of which an open-loop or closed-loop controllable gas flow is generated in the gas-guiding arrangement 30, 30′. The control arrangement 50 is also used to control the local gas distribution in the gas-guiding arrangement with the aid of the valves 44.

Whereas the sketch in FIG. 1 for reasons of clarity shows gas-guiding arrangements 30, 30′ that are only arranged above the substrate 10 in the treatment chambers 20, and therefore only permit a one-sided gas actuation of the substrate 10, the detailed illustration of the heat-treatment chamber 21 (FIG. 2a) shows that the gas-guiding arrangement 30 in general has outlet openings 32 both above and below the substrate 10, and so there can be a two-sided convective temperature-control of the substrate 10. In order to set the temperature of the gas that is guided onto the substrate 10 via the gas-guiding arrangement 30, 30′, the gas circuit 40 shown in FIG. 2a indicates an electrically operable (resistance) heating device 41, by means of which the circulating gas is heated to a desired temperature (that can for example be measured with the aid of thermo-elements 46 in the gas-guiding arrangement 30). The power of the heating device 41 is regulated with the aid of the control arrangement 50. As an alternative to the heating device 41 (or in addition thereto), a heat exchanger 42 can be used to heat the gas in the heat-treatment chamber 21—and also to cool the gas in the cooling chamber 21′. Furthermore, the gas circuit 40 can contain a drying device 43 and/or a filter device for drying or cleaning the circulating gas. Hence the air or the (industrial) gas in the treatment chamber 20 serves as a heat conductor; a partial flow is guided out of the interior of the processing chamber 20 for process-technical treatment of the gas, subjected to a change (heating, cooling, dehumidifying, . . . ) in the gas-guiding arrangement 30 and thereafter returned to the interior 8 again. Furthermore, the gas circuit can be connected to a gas disposal device 45, to which gas from the gas circuit 40 can be supplied when necessary.

In addition to the convection heating of the substrate 10 with the aid of the gas-guiding arrangement 30, the substrate can be heated with the aid of electromagnetic radiation, more particularly infrared radiation. For this purpose, heating means 47 can be provided in the heat-treatment chamber 21 and these means are illustrated in FIG. 2a as heatable quartz rods. Alternatively, or in addition thereto, thermal energy can be introduced into the heat-treatment chamber 21 via windows, for example as (pulsed) electromagnetic radiation. If such a heating means 47 is provided in the heat-treatment chamber 21, the heat transfer onto the substrate 10 is brought about both with the aid of radiation (due to the heating means 47) and due to convection (as a result of the gas). In order to concentrate the thermal radiation onto the substrate or to avoid damage to the chamber walls 27, reflectors can be provided in the interior 8 of the processing chamber 20 or on the chamber walls 27. In particular, the inner sides of the walls 27 can be coated with a material that has a high reflectivity in the wavelength spectrum of the heating means 47 and thus acts as a reflector and as a heat shield.

In order to thermally shield the heat-treatment chamber 21, which can be at a high temperature during operation, from the surroundings 2, the heat-treatment chamber 21 from FIGS. 2a and 2b comprises, in addition to an inner chamber 3 (the actual heating chamber), an outer chamber 4, which surrounds the inner chamber 3 and serves as a thermoinsulation shield of the inner chamber 3. The outer chamber 4 is a vacuum chamber that can be evacuated with the aid of a pump 5.

Additionally, or as an alternative thereto, the wall 27 of the heat-treatment chamber 21 can have a temperature-control arrangement. In particular, this temperature-control arrangement can be designed as a channel system 7 of cooling or heating channels running in the wall 27 (and indicated in a region of the wall 27 in FIG. 2a), which can be used to keep the wall at a predefined temperature. Hence, the channel system 7 thermally shields the heated or cooled interior 8 of the treatment chamber 20 from the surroundings 2 or the outer chamber 4 and forms a thermoinsulation shield of the interior 8 with respect to the surroundings. The channel system 7 forms part of a cooling or heating circuit for a liquid coolant (e.g. an oil), which circulates through the channels in the chamber wall 7.

The device 1 affords very rapid heating of the substrate 10 (or selected substrate regions) with a heating rate >20 degrees/s up to a temperature region of approximately 650° C. in the heat-treatment chamber 21 and very rapid cooling of the substrate 10 in the cooling chamber 21′ separated from the heat-treatment chamber 21, with cooling rates >20 degrees/s from the temperature region of approximately 650° C. down to room temperature. The heating and cooling can take place both on one side (as shown in FIG. 1) and on both sides (as shown in FIGS. 2a and 2b) of the substrate.

The device 1 and the treatment chamber 20 are particularly suitable for the heat treatment of substrates in the course of producing transparent conducting oxide (TCO) layers, as are used in the production of flat-panel screens and solar cells. Furthermore, the device 1 is suitable for use in the production of thin-film solar cells or thin-film solar modules with a substrate layer made of a glass or quartz, onto which a Mo-layer as an electrode and a functional layer made of a copper indium diselenide (CIS) semiconductor or a copper indium gallium sulphur selenide (CIGSSe) semiconductor should be applied.

1. A treatment chamber for thermal processing of an areal substrate comprising;
a transport arrangement for conveying and supporting the substrate during the thermal processing;
and with a gas-guiding arrangement for convective heating or cooling of the substrate the gas-guiding arrangement having outlet openings for the gas in a region facing the substrate; and
a removal arrangement for removal of the gas introduced into the treatment chamber via the gas-guiding arrangement;
wherein the gas-guiding arrangement comprising comprises a tubular gas distributor with a multiplicity of nozzle sections directed at the substrate, with the outlet openings being arranged at the ends of said nozzle sections; and
wherein the removal arrangements are embodied as elongate removal domes arranged along the tube sections.

2. The treatment chamber as claimed in claim 1, wherein the tubular gas distributor is arranged approximately parallel to a substrate surface.

3. The treatment chamber as claimed in claim 1 or 2, wherein the transport arrangement permits an areal arrangement of the substrates.

4. The treatment chamber as claimed in claim 3, wherein the tubular gas distributor and/or the nozzle sections has or have controllable valves for regulating the gas flow.

5. The treatment chamber as claimed in claim 3, wherein nozzle section cross sections taper in a direction towards the outlet openings.

6. The treatment chamber as claimed in claim 3, wherein the nozzle sections protrude approximately perpendicularly from the tube sections in a direction of the substrate surface.

7. The treatment chamber as claimed in claim 1, wherein the treatment chamber forms an enclosed space during the thermal processing of the substrate.

8. The treatment chamber as claimed in claim 7, wherein the gas-guiding arrangement forms part of a closed gas-guiding circuit.

9. The treatment chamber as claimed in claim 1, wherein the gas-guiding arrangement contains a heat exchanger for heating or cooling the gas supplied to the substrate surface.

10. The treatment chamber as claimed in claim 1, wherein the gas-guiding arrangement contains at least one pump.

11. The treatment chamber as claimed in claim 1, wherein the gas-guiding arrangement contains a drying device and/or a filter device for drying or cleaning the gas supplied to the substrate surface.

12. The treatment chamber as claimed in claim 10, wherein the gas-guiding arrangement comprises a control arrangement for regulating a power of the pump and/or for regulating the flow through the tubular gas distributors and/or through the nozzle sections.

13. The treatment chamber as claimed in claim 1, wherein the treatment chamber comprises sealable openings for supplying and removing the substrate.

14. The treatment chamber, as claimed in claim 1, wherein the treatment chamber has a thermoinsulation shield.

15. The treatment chamber as claimed in claim 14, wherein the thermoinsulation shield is designed as an outer chamber that can be sealed in a gas-tight fashion and surrounds an inner chamber that can be sealed in a gas-tight fashion.

16. The treatment chamber as claimed in claim 15, wherein the thermoinsulation shield is formed by a temperature-control arrangement arranged in the region of the wall of the treatment chamber.

17. The treatment chamber as claimed in claim 16, wherein the temperature-control arrangement is formed by a system of cooling or heating channels.

18. The treatment chamber as claimed in claim 16, wherein the temperature-control arrangement forms part of a heating or cooling circuit in which a liquid temperature-control medium circulates.

19. The treatment chamber as claimed in claim 1, wherein the treatment chamber is a cooling chamber.

20. The treatment chamber as claimed in claim 1, wherein the treatment chamber is a heat-treatment chamber.

21. The treatment chamber as claimed in claim 20, wherein the gas-guiding arrangement contains an electrically operable heating device for heating the gas.

22. The treatment chamber as claimed in claim 20, wherein a heating means for emitting thermal energy is arranged in an interior of the treatment chamber.

23. The treatment chamber as claimed in claim 1, wherein inner walls of the treatment chamber at least in sections comprise a reflecting material.

24. A chamber for thermal processing of a substrate with a heat-treatment chamber and/or a cooling chamber as claimed in claim 1.

25. A method for thermal processing of an areal substrate in a treatment chamber, comprising:
a transport arrangement conveys and supports the substrate during the thermal processing, and
convective heating or cooling of the substrate by means of a gas-guiding arrangement, the gas-guiding arrangement having outlet openings for the gas in a region facing the substrate, and the gas-guiding arrangement comprises comprising a tubular gas distributor with a multiplicity of nozzle sections directed at the substrate, with the outlet openings being arranged at ends of said nozzle sections; and
a removal arrangement removing the gas introduced into the treatment chamber via the gas-guiding arrangement, wherein the removal is carried out by means of the removal arrangements which are embodied as elongate removal domes arranged along the tube sections.
